(19) United States
(12) Patent Application Publication
(10) Pub. No.: US 2010/0197360 A1
(43) Pub. Date: Aug. 5, 2010

(54) EARPHONE DEVICE AND METHOD USING IT

(75) Inventors: Bo-Ram NAMGOONG, Seoul (KR); Ju-Young PARK, Seoul (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/696,274

(22) Filed: Jan. 29, 2010

(30) Foreign Application Priority Data
Feb. 2, 2009 (KR) 10-2009-0007951

(51) Int. Cl. H04M 1/00

(52) U.S. Cl. 455/569.1

(57) ABSTRACT

An earphone device and a method for operation saves power and time when a user is interrupted from listening to communications. The earphone device includes a cable of a predetermined length, an ear jack, an earphone, a light sensor, and a controller. The ear jack is installed at one end of the cable, and is preferably arranged into an ear jack hole provided in a terminal for providing sound or voice reproduction. The earphone is installed at the other end of the cable and includes a speaker, and preferably inserted into and/or on a user's ear. The light sensor is positioned to periodically sense brightness. The controller determines whether or not the earphone is actually in use (or non-use) based on the brightness periodically sensed by the light sensor. The transmission of audio signals to the earphone is enabled/disabled according to the determination by the earphone.

### CLAIM OF PRIORITY

This application claims the benefit of priority under 35 U.S.C. §119(a) from a patent application entitled “EARPHONE DEVICE AND METHOD USING IT” filed in the Korean Intellectual Property Office on Feb. 2, 2009 as Serial No. 10-2009-0007951, the contents of which are incorporated by reference in its entirety.

### BACKGROUND OF THE INVENTION

1. Field of the Invention

The present invention relates to an earphone device applied to terminals outputting sound. More particularly, the present invention relates to an apparatus and method for an earphone device that prevents the unnecessary power consumption of a terminal.

2. Description of the Related Art

An earphone device typically comprises a small piece of equipment which a user wears over or inside a user's ear so that user can listen to sound without anyone else hearing. The earphone device is in communication with a terminal outputting an audio signal by wire or wireless and is provided the audio signal from the terminal and outputs sound depending on the audio signal. A terminal applying the earphone device is various such as an MPEG-1 Audio Layer 3 (MP3) player, a Portable Digital Assistant (PDA), a notebook computer, a desktop Personal Computer (PC), etc.

In general, the earphone device includes a cable, an ear jack at one end of the cable and of an earphone including a speaker unit at the other end of the cable. The ear jack is inserted into an ear jack connector of the terminal, and the earphone is worn over or inside a user's ear.

In order to utilize the aforementioned earphone device, the user inserts the ear jack into the ear jack connector of the terminal and enables a corresponding operation (e.g., music reproduction) of the terminal, thereby listening through the earphone.

In the case where a user removes the earphones of an earphone device from his/her ears while listening to music, the music is nevertheless continuously reproduced until he/she presses a control button such as an off button of the terminal. Here, if the user decides to put the earphones on again, he/she inconveniently has to search the last listening portion of music. Further, this causes a problem resulting in the unnecessary power consumption of the terminal because the music is continuously reproduced even when the earphones are not attached to the ear for listening.

### SUMMARY OF THE INVENTION

The present invention provides an earphone device that outputs a signal controlling a terminal communicating with the earphone device according to whether or not the earphone device is currently in use.

An exemplary aspect of the present invention is to provide an earphone device configured to disable a corresponding function of a terminal transmitting audio signals to the earphone device, when earphones are removed from a user's ears, so as increase the user convenience of the terminal, and a method for operation.

Another exemplary aspect of the present invention is to provide an earphone device configured to automatically disable a corresponding function of a terminal and prevent the unnecessary power consumption of the terminal, when a user does not use the earphones for a predetermined amount of time, and a method for operation.

The above exemplary aspects are achieved by providing an earphone device and a method for operation.

In accordance with an exemplary aspect of the present invention, an earphone device connecting to a terminal having a function of sound or voice reproduction and forwarding a reproduced sound or voice to a user is provided. The device includes a cable of a predetermined length, an ear jack, an earphone, a light sensor, and a controller. The ear jack is installed at one end of the cable, and is inserted into an ear jack hole provided in the terminal to be electrically connected. The earphone is installed at the other end of the cable and worn over or inside a user's ear, and has a speaker unit outputting sound. The light sensor is installed in an area of the earphone and so as to periodically sense brightness. The controller is provided in the terminal to determine a use or non-use of the earphone using the brightness periodically sensed by the light sensor and control a corresponding enabling function.

In accordance with another exemplary aspect of the present invention, an earphone device for performing a wireless local communication with a terminal having a function of sound or voice reproduction and forwarding a reproduced sound or voice to a user includes an earphone, a light sensor, and a controller. The earphone has a speaker unit that is worn over or inside a user's ear. The light sensor is positioned in the earphone to periodically sense brightness. The controller is provided in the terminal to determine whether or not the earphone is being used based on the brightness sensed by the light sensor. The controller enables/disables communication of audible information based on whether or not the light sensor senses brightness.

In accordance with still another exemplary aspect of the present invention, a method for operating an earphone device electrically connecting with a terminal for reproducing voice or sound, and having a light sensor for sensing brightness, includes connecting the earphone device to the terminal, calculating a value obtained by receiving and averaging brightness periodically sensed by the light sensor, determining if the calculated average value is within a designed/predetermined range. If the calculated average value of brightness is within the predetermined range, enabling a corresponding function through an earphone and, if the calculated average value is outside of the predetermined range, disabling the corresponding function through the earphone.

In accordance with further another exemplary aspect of the present invention, a method for operating a wireless local communication earphone device for performing a wireless local communication with a terminal having a function of sound or voice reproduction and delivering a reproduced sound or voice to a user is provided. The method includes communication—connecting the earphone device with the terminal, calculating a value obtained by receiving and averaging brightness periodically sensed by the light sensor, determining if the calculated average value is within a predetermined range, and, if the calculated average value is within the a predetermined range, enabling a corresponding function through an earphone and, the calculated average value is outside of the predetermined range, disabling the corresponding function through the earphone.

In the third and fourth exemplary aspects, a method for receiving brightness currently sensed in the light sensor in place of the value obtained by averaging the brightness periodically sensed in the light sensor, determining if the brightness is within a predetermined range, and enabling/disabling a corresponding function through the earphone is also possible.

Other exemplary aspects, advantages and salient features of the invention will become more apparent to a person of ordinary skill in the art from the following detailed description, which, taken in conjunction with the annexed drawings, discloses certain exemplary embodiments of the invention in more detail.

### BRIEF DESCRIPTION OF THE DRAWINGS

The above features and advantages of certain exemplary embodiments of the present invention will become more apparent to a person of ordinary skill in the art from the following detailed description taken in conjunction with the accompanying drawings, in which:

FIG. 1 is a perspective diagram illustrating an earphone device according to an exemplary embodiment of the present invention;

FIG. 2 is a block diagram illustrating a terminal and an earphone device connected with the terminal according to an exemplary embodiment of the present invention;

FIG. 3 is a flow diagram illustrating a procedure of controlling an earphone device according to an exemplary embodiment of the present invention;

FIG. 4 is a perspective diagram illustrating a Bluetooth earphone device according to another exemplary embodiment of the present invention; and

FIG. 5 is a block diagram illustrating a terminal and a Bluetooth earphone device connected with the terminal according to another exemplary embodiment of the present invention.

Throughout the drawings, like reference numerals will be understood to refer to like parts, components and structures.

### DETAILED DESCRIPTION

The following description, with reference to the accompanying drawings, is provided to assist a person of ordinary skill in the art with a comprehensive understanding of exemplary embodiments of the invention. The description includes various specific details to assist in that understanding but these details are to be regarded as merely exemplary. Accordingly, those of ordinary skill in the art will recognize that various changes and modifications of the exemplary embodiments described herein can be made without departing from the spirit of the invention and the scope of the appended claims. Also, descriptions of well-known functions and constructions may be omitted for clarity and conciseness so as not to obscure appreciation of the present invention by a person of ordinary skill with such well-known functions and constructions.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims.

It is to be understood that the singular forms “a”, “an”, and “the” include plural references unless the context clearly dictates otherwise. Thus, for example, reference to “a component surface” typically includes reference to one or more of such surfaces.

By the term “substantially” typically means that the recited characteristic, parameter, or value need not be achieved exactly, but that deviations or variations, including for example, tolerances, measurement error, measurement accuracy limitations and other factors known to those skilled in the art, and may occur in amounts that do not preclude the effect the characteristic was intended to provide.

Preferred exemplary embodiments of the present invention will be described below with reference to the accompanying drawings. Exemplary embodiments of the present invention provide an earphone device outputting sound in accordance with audio signals received from terminals. In particular, the present invention provides an apparatus and method for an earphone device that controls a terminal communicating with the earphone device according to the use or non-use of the earphone device.

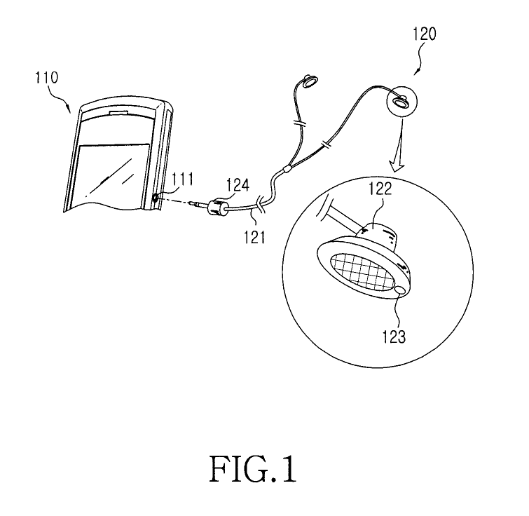

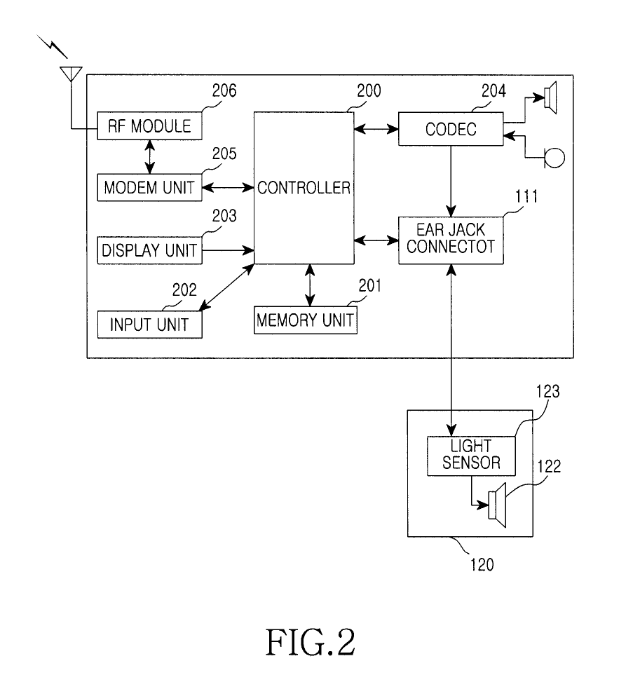

FIG. 1 is a perspective diagram illustrating an earphone device according to an exemplary embodiment of the present invention. FIG. 2 is a block diagram illustrating a terminal and an earphone device connected with the terminal according to an exemplary embodiment of the present invention.

The terminal according to exemplary embodiments of the present invention may include various types of protocols that may include nut are in no way limited to an MPEG-1 Audio Layer 3 (MP3) player having a function of reproducing various kinds of sound, music, voice, etc., a Portable Digital Assistant (PDA), a notebook computer, a desktop Personal Computer (PC), etc., just to name a few of the various types of terminals.

Referring now to FIGS. 1 and 2, the terminal 110 includes an ear jack hole 111 (e.g. socket) for receiving an ear jack 124 so as to output audio signals upon an electrical connection between the ear jack 124 and the socket 124. The ear jack hole/socket 111 receives the ear jack 124 of an earphone device 120 described later, thus electrically connecting the portable terminal 110 with the earphone device 120. For example, the ear jack hole 111 may comprise a four-terminal ear jack port having a cylindrical shape. In addition, when the ear jack is a 10-pin connector, the ear jack hole 111 may be a 10-pin connector port. The earphone device 120 includes a cable 121 of a predetermined length, the ear jack 124 installed at one end of the cable 121 and inserted into the ear jack hole 111 of the terminal, and an earphone 122 installed at the other end of the cable 121 and worn over or inside a user's ear. The earphone 122 comprises a speaker unit outputting sound. The earphone 122 may have a shape that is easy to be worn over or inside the user's ear. A person of ordinary skill in the art should understand and appreciate that while the current exemplary embodiment provides a wired connection between the earphone and the portable terminal, a wireless earphone utilizing a wireless communication protocol, including but in no way limited to protocols such as Bluetooth, 802.11xx, can also be used.

Also, according to an exemplary embodiment of the present invention, a light sensor 123 is arranged in the earphone 122 in a position such that the light sensor 123 does not sense external light shined into the user's ear when the earphone 122 is worn over or inside the user's ear. That is, the light sensor 123 senses different brightness from brightness of the outside of the user's ear by wearing the earphone 122 over or inside the user's ear.

In more detail, after the earphone device 120 connects to the ear jack hole 111 of the terminal 110, the light sensor 123 periodically or continuously senses levels of brightness and forwards the sensed levels of brightness to the terminal 110 via the cable 121. The controller 200 of the terminal 110 averages the levels of brightness received from the light sensor 123 in a predetermined way and calculates an average value. If the calculated average value is within a predetermined range, the controller 200 may enable a corresponding function of the terminal 110 using the earphone 122. Accordingly, the light sensor 123 is configured to apply a signal to the controller 200 of the terminal 110 through the cable 121 and the ear jack 124. This application is easier in realization if the ear jack 124 is a 10-pin connector.

The light sensors 123, for example, can be installed in both earphones and preferably warn over or inside the left and right ears so as to increase the accuracy of control. Also, the light sensor 123 may be installed only in one earphone and configured such that a user selectively uses a control mode or a non-control mode as desired using only one earphone in which the light sensor 123 is installed. It is also within the spirit and scope of the invention that there could be only one earphone. Furthermore, the light sensor 123 configured in the earphone(s) may comprise a plurality of sensors to increase the accuracy of control.

With reference to FIG. 2 the controller 200 of the terminal 110 preferably controls the general functionality of the terminal 110. Particularly, the controller 200 determines whether the earphone 122 is removed from or inserted into the inside of an ear using brightness periodically or continuously received from the light sensor 123 so that the controller 200 enables or disables an ongoing function relevant to sound. For example, in case that a user listens to sound with the earphone 122 while viewing a video, if the earphone 122 is removed from his/her ear, the controller 200 may identify the removal of the earphone 122 through brightness received from the light sensor 123 and then, pause or end the video. Also, if the earphone 122 is again worn over or inside the ear, the controller 200 identifies the wearing of the earphone 122 through brightness received from the light sensor 123 and then, again outputs the paused video.

In addition, a memory unit 201, a display unit 203, a COder-DECoder (CODEC) 204, a modem unit 205, a Radio Frequency (RF) module 206 and a key input unit 202 perform the well-known general functions of the terminal 110 and thus, their descriptions are omitted.

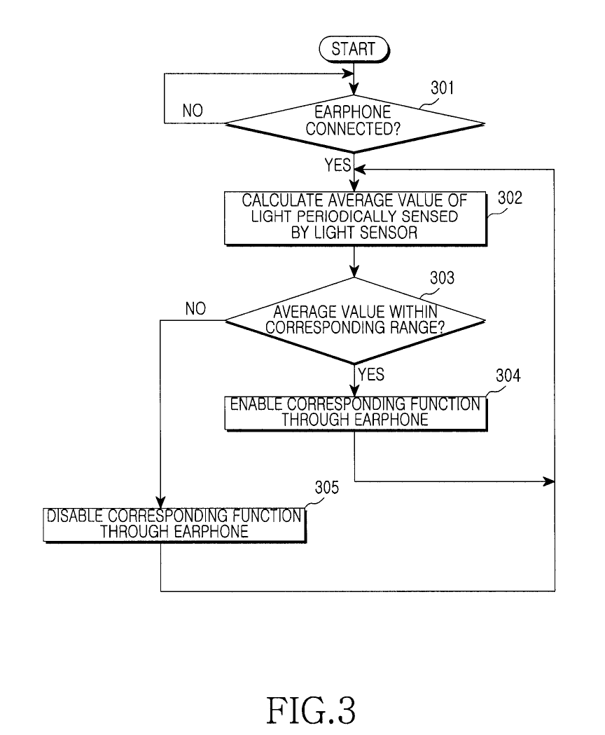

FIG. 3 is a flow diagram illustrating an exemplary procedure of controlling an earphone device according to an exemplary embodiment of the present invention. FIG. 3 illustrates a procedure in which the controller 200 receives a periodically sensed brightness from the earphone device 120 with the light sensor 123 and controls a corresponding function currently enabled in a terminal.

Referring now to FIG. 3, in step 301, the controller 200 identifies if the earphone 122 of the earphone device 120 is connected to the terminal. Undoubtedly, even when the earphone 122 is disconnected from the terminal, the terminal can reproduce music, etc., but this state is excluded in that, if the ear jack 124 is disconnected, listening is impossible.

Then, in step 302, the controller 200 receives brightness values periodically sensed in the light sensor 123 and calculates an average value using a predetermined scheme.

After that, in step 303, the controller 200 determines whether or not the calculated average value is within a predetermined range. The predetermined range can be a range of brightness that the light sensor 123 can sense in a user's ear. If the calculated average value is within the predetermined range in step 303, the controller 200 proceeds to step 304 and enables a corresponding function through the earphone 122. That is, if the earphone 122 is inserted into the user's ear, the controller 200 performs an enabling operation of reproducing music through the terminal or initiating a telephony operation through the terminal.

Also, a step 303, if the calculated average value is not within the predetermined range, the controller 200 proceeds to step 305 and disables the corresponding function through the earphone 122. That is, if the earphone 122 is removed from the inside of the user's ear or is not yet inserted into the user's ear, the controller 200 performs a disabling operation of pausing currently reproduced music, etc. or initiating or maintaining an off operation for a currently enabled function. According to some cases, the controller 200 may also perform an operation of decreasing a volume in reproduction.

In step 303, the controller 200 uses an average value obtained by averaging brightness sensed by the light sensor 123 during a predetermined time period. However, a person of ordinary skill in the art should understand and appreciate that instead of the average value, real-time brightness currently sensed by the light sensor 123 can be also used.

Still referring to FIG. 3, the controller 200 performs steps 304 and 305 and then, returns to step 302 and again performs subsequent steps.

In addition the present invention can be embodied in a hands-free ear microphone device. In this case, a microphone unit outputting an audio signal to the terminal may be installed on a cable. Also, in this case, an enabling state of a terminal by the light sensor can be accomplished by an operation of initiating call reception, and a disabling state of the terminal can be accomplished by an operation of ending the call reception.

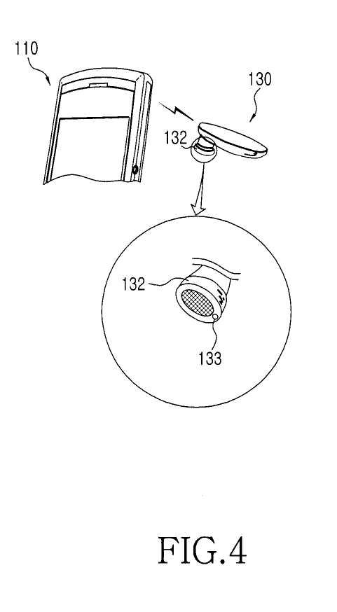

Further, an earphone device with a light sensor according to an exemplary embodiment of the present invention may also comprise a Bluetooth earphone device (130 of FIG. 4) capable of performing a wireless local communication with a terminal.

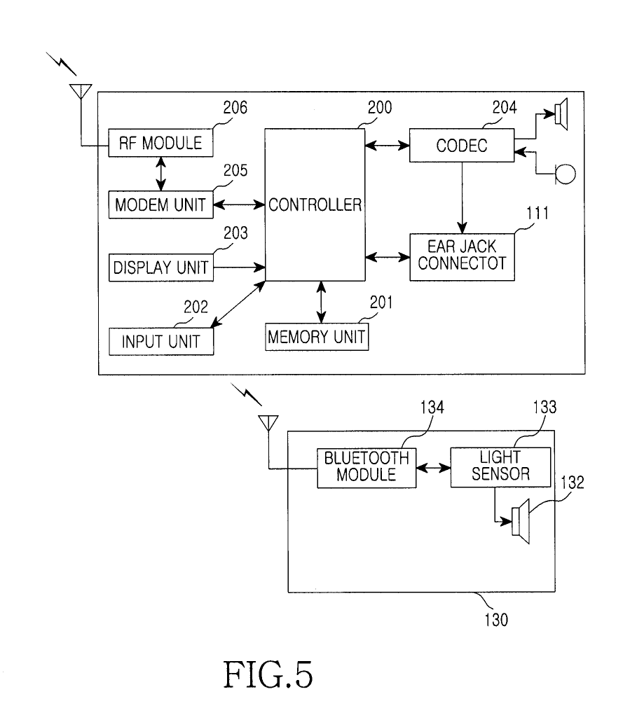

FIG. 4 is a perspective diagram illustrating a Bluetooth earphone device according to another exemplary embodiment of the present invention. FIG. 5 is a block diagram illustrating a terminal and a Bluetooth earphone device connecting with the terminal according to another exemplary embodiment of the present invention.

Referring now to FIGS. 4 and 5, the Bluetooth earphone device 130 includes a Bluetooth module 134 for performing a wireless local communication with the RF module 206 of the terminal, and a light sensor 133 according to an exemplary embodiment of the present invention.

The Bluetooth earphone device 130 may perform a control flow of FIG. 3. Particularly, the Bluetooth earphone device 130 communicates brightness periodically sensed by the light sensor 133 with the controller 200 using a non-wired, wireless local communication.

The terminal 110 may connect with at least one or more Bluetooth earphone devices 130. Here, the controller 200 of the terminal may identify brightness provided from each of the Bluetooth earphone devices 130 and then, determine whether to enable or disable a corresponding function associated with each of the Bluetooth earphone devices 130.

A procedure for enabling or disabling a function relevant to the Bluetooth earphone devices by transmitting, for example, the sensed brightness itself from the Bluetooth earphone device to the terminal and receiving the sensed brightness in the controller of the terminal as described above has been proposed. However, without limiting the invention to this exemplary embodiment, the Bluetooth earphone device can include a controller for performing a general control of the Bluetooth earphone device. The controller of the Bluetooth earphone device transmits to the terminal a control command signal dependent on the brightness values received from the light sensor and, by doing so, the portable terminal can enable or disable a corresponding function associated with the Bluetooth earphone device.

Without limiting the present invention to this exemplary embodiment, a wired earphone device of FIG. 1 can also include a controller that transmits to the terminal a control command signal for enabling or disabling a corresponding function dependent on brightness received from a light sensor. The controller of the wired earphone device may be configured in an earphone or cable.

There are many modifications that can be made of the aforementioned exemplary embodiments that still lie with in the scope of the appended claims. For example, while a light sensor is used in the exemplary embodiments, it is possible that a pressure sensor, contact switch, magnetic sensor, electric sensor, heat sensor, blood flow sensor, etc., just to name a few possibilities, can be used to notify the terminal as to whether the earphone is in use or non-use.

In conclusion, if the earphone of the earphone device according to an exemplary embodiment of the present invention is not in use, that is the earphone is removed over or inside user's ears, a relevant function of the terminal via the earphone is stopped or paused. Conversely, when an earphone is used again, that is the earphone is worn over or inside user's ear, the paused function of the terminal via the earphone is continued or the stopped function of the terminal via the earphone is restarted. Also, the earphone device according to the present invention has an effect of, when the earphone is not in use, pausing a corresponding function, thus being able to prevent the unnecessary power consumption of the terminal.

While the invention has been shown and described with reference to certain preferred embodiments thereof, it will be understood by those skilled in the art that various changes in form and details may be made therein without departing from the spirit and scope of the invention as defined by the appended claims and their equivalents.

What is claimed is:

1. An earphone device for connecting to a terminal having a function of sound or video reproduction and forwarding a reproduced sound to a user through an earphone inserted into or arranged on a user's ear, the device comprising:
a cable of a predetermined length;
an ear jack installed at one end of the cable, and inserted into an ear jack hole provided in the terminal having the function of sound or video reproduction, for electrical connection;
an earphone installed at the other end of the cable, having a speaker unit outputting sound, and worn over or inside the user's ear; and
a sensor coupled with the earphone and sensing that the earphone is arranged over, on, or inside the user's ear.

2. The device of claim 1, wherein the sensor comprises a sensor selected from the group consisting of a pressure sensor, contact sensor, magnetic sensor, electric sensor, heat sensor, and blood flow sensor.

3. The device of claim 1, wherein the sensor comprises a light sensor, and brightness is sensed to determine whether the earphone is arranged over or inside the user's ear.

4. The device of claim 3, wherein the device further comprises a controller for determining a use or non-use of the earphone by using the brightness sensed by the light sensor to determine whether the earphone is currently being worn by the user, and forwarding a control signal controlling a corresponding function to the sound or video reproducing terminal.

5. The device of claim 3, wherein the sound or video reproducing terminal determines a use or non-use of the earphone using the brightness sensed by the light sensor and controls a corresponding function.

6. The device of claim 4, wherein, if a value obtained by averaging the brightness periodically sensed by the light sensor is within a predetermined range, the controller enables the corresponding function and, if the value is not within the predetermined range, the controller disables the corresponding function.

7. The device of claim 5, wherein, if a value obtained by averaging the brightness periodically sensed by the light sensor is within a predetermined range, the controller enables the corresponding function and, if the value is not within the predetermined range, disables the corresponding function.

8. The device of claim 4, wherein, if a current brightness value sensed by the light sensor is within a predetermined range, the controller enables the corresponding function and, if the value is not within the range, disables the corresponding function.

9. The device of claim 5, wherein, if a current brightness value sensed by the light sensor is within a predetermined range, the controller enables the corresponding function and, if the value is not within the predetermined range, disables the corresponding function.

10. The device of claim 4, wherein the corresponding function comprises at least one of ‘pause’, ‘stop’, and ‘end’.

11. The device of claim 5, wherein the corresponding function comprises at least one of ‘pause’, ‘stop’, and ‘end’.

12. The device of claim 3, wherein the light sensor is installed in the earphone so as to contact inside the user's ear sufficient to block outside light.

13. The device of claim 12, wherein the contact inside the user's ear comprises an edge of the earphone or a surface from which sound is output.

14. The device of claim 9, wherein the light sensor comprises more a plurality of light sensors making contact inside the user's ear.

15. An earphone device for performing a wireless local communication with a terminal having a function of sound or video reproduction and forwarding a reproduced sound to a user, the device comprising:
an earphone having a speaker unit for outputting a sound, and adapted for insertion into a user's ear; and
a light sensor installed in the earphone and sensing brightness.

16. The device of claim 14, further comprising:
a controller for receiving a brightness signal from the light sensor that indicates brightness is sensed, said controller determining a use or non-use of the earphone by the signal received from the light sensor, and for generating a control signal controlling a corresponding function; and
a transmitter for transmitting the control signal generated in the controller to the sound or video reproducing terminal.

17. The device of claim 15, wherein the sound or video reproducing terminal comprises:
a receiver for receiving the brightness signal sensed by the light sensor; and
a controller for determining a use or non-use of the earphone using the brightness signal sensed by the light sensor and controlling a corresponding function.

18. The device of claim 16, wherein, if a mean value of the brightness signal obtained by averaging values of the brightness signal periodically sensed by the light sensor is within a predetermined range, the controller of the earphone device or the controller of the sound or video reproducing terminal enables the corresponding function and, if not being within the predetermined range, disables the corresponding function.

19. The device of claim 17, wherein, if the mean value obtained by averaging the brightness signals periodically sensed by the light sensor is within a predetermined range, the controller of the earphone device or the controller of the sound or video reproducing terminal enables the corresponding function and, if not being within the predetermined range, disables the corresponding function.

20. The device of claim 16, wherein, if a value of a current brightness signal sensed by the light sensor is within a predetermined range, the controller of the earphone device or the controller of the sound or video reproducing terminal enables the corresponding function and, if not being within the predetermined range, disables the corresponding function.

21. The device of claim 17, wherein, if a value of a current brightness signal sensed by the light sensor is within a predetermined range, the controller of the earphone device or the controller of the sound or video reproducing terminal enables the corresponding function and, if not being within the predetermined range, disables the corresponding function.

22. The device of claim 15, wherein the light sensor is installed in the earphone so as to make contact with inside the user's ear.

23. The device of claim 22, wherein light sensor makes contact with an inside of the user's ear along an edge of the earphone or a surface from which sound is output.

24. The device of claim 22, wherein the light sensor comprises a plurality of light sensors making contact with an inside of the user's ear.

25. The device of claim 16, wherein the corresponding function comprises at least one of ‘pause’, ‘stop’, and ‘end’.

26. The device of claim 17, wherein the corresponding function is at least one of ‘pause’, ‘stop’, and ‘end’.

27. A wireless local communication earphone device connecting to a terminal having a function of sound or video reproduction and forwarding a reproduced sound to a user, the device comprising:
a controller for performing a control of a general operation; and
a plurality of earphones having light sensors for sensing external brightness, and the earphones performing a wireless communication with the terminal having the sound or video reproduction function,
wherein the sound or video reproducing terminal comprises a controller for receiving brightness signals from the light sensors of the plurality of earphones, and enabling or disabling a corresponding function based on a value of the brightness signals.

28. A method for operating an earphone device electrically connecting to a terminal for reproducing sound or video, and having a sensor for sensing the earphone is being worn by a user, the method comprising:
connecting the earphone device to the sound or video reproducing terminal;
sensing contact with the user by the sensor;
determining if the sensed contact is within a predetermined range; and
if the contact is within the predetermined range, enabling a corresponding function and, if the contact sensed is not within the predetermined range, disabling the corresponding function.

29. The method according to claim 28, wherein the sensor comprises a light sensor, and contact with the user's ear is in accordance with a brightness signal sensed by the light sensor.

30. The method according to claim 29, wherein the sensor comprises a sensor selected from the group consisting of a pressure sensor, contact sensor, magnetic sensor, electric sensor, heat sensor, and blood flow sensor.

31. The method of claim 29, wherein the enabling of the corresponding function reproduces sound or initiates a telephony operation through the sound or video reproducing terminal.

32. The method of claim 29, wherein the disabling of the corresponding function stops or pauses a reproduced sound, ends reproduction, or ends a telephony state.

33. The method of claim 29, wherein connecting the earphone device to the sound or video reproducing terminal connects by wired or wireless.

34. The method of claim 29, wherein sensing the brightness by the light sensor is periodically performed, and wherein determining if a value of the sensed brightness is within the preset range includes calculating a value obtained by averaging a value of brightness periodically sensed by the light sensor and determining if the average value is within the predetermined range.

35. The method of claim 34, further comprising:
forwarding the average value of the brightness sensed in the light sensor of the earphone, to the sound or video reproducing terminal; and
executing a control corresponding to the received average value of brightness.

36. The method of claim 34, further comprising:
forwarding a control signal corresponding to the average value of the brightness sensed in the light sensor of the earphone, to the sound or video reproducing terminal; and
executing a control corresponding to the received control signal.

37. The method of claim 29, further comprising:
forwarding the brightness value sensed by the light sensor of the earphone, to the sound or video reproducing terminal; and
executing a control corresponding to the received brightness value.

38. The method of claim 29, further comprising:
forwarding a control signal corresponding to the brightness value sensed in the light sensor of the earphone, to the sound or video reproducing terminal; and
executing a control corresponding to the received control signal.

39. The method of claim 33, further comprising:
wireless connecting a plurality of the earphone devices to the sound or video reproducing terminal;
sensing a value of brightness in the light sensors of the plurality of wirelessly connected earphone devices, respectively; and
enabling or disabling functions of the wirelessly connected earphone devices depending on the respective brightness values.
